(19) United States
(12) Patent Application Publication
(10) Pub. No.: US 2020/0265325 A1
(43) Pub. Date: Aug. 20, 2020

(54) KNOWLEDGE-DRIVEN AUTOMATED SCIENTIFIC MODEL EXTRACTION, EXPLANATIONS, AND HYPOTHESIS GENERATION

(71) Applicant: GENERAL ELECTRIC COMPANY, Schenectady, NY (US)

(72) Inventors: Alfredo GABALDON ROYVAL, Clifton Park, NY (US); Natarajan CHENNIMALAI KUMAR, Freemont, CA (US)

(21) Appl. No.: 16/791,654

(22) Filed: Feb. 14, 2020

Related U.S. Application Data
(60) Provisional application No. 62/805,695, filed on Feb. 14, 2019.

(51) Int. Cl. G06N 5/02; G06F 16/36; G06F 16/901; G06F 16/903

(52) U.S. Cl. CPC G06N 5/022; G06F 16/90335; G06F 16/9024; G06F 16/367

(57) ABSTRACT

A system, method, and computer-readable medium, to receive a query to execute against a knowledge graph, the knowledge graph representing information pertaining to a particular scientific domain and the query including at least one variable represented by the knowledge graph; examining the knowledge graph to identify variables therein that are also specified in the query; generate a scientific model based on the query and the identified variables in the knowledge graph the execution of the model providing an answer to the query; and transmitting a record of the generated model to a data store and persisting the record in the data store.

### BACKGROUND

The field of the present disclosure generally relates to knowledge graphs, and more particularly, to aspects of assembling and executing scientific model(s) based on information in a knowledge graph.

Data regarding an area of interest or a domain may reside in a number of data sources. In some instances, the data sources might include academic and scientific papers, software documentations, software source code, news articles, social media, data stores of these and/or other types data structures and representations. In some instances, some data, even when collected or otherwise obtained or identified as being at least somewhat related or of interest, might not be easily navigated, queried, represented, and/or explained.

Accordingly, in some respects, a need exists for methods and systems that provide an efficient and accurate mechanism for efficiently querying, explaining, and exercising scientific models.

### BRIEF DESCRIPTION OF THE DRAWING

FIG. 1 is an illustrative depiction of an example of knowledge graph of domain, in accordance with some embodiments herein;

FIG. 2 is an illustrative depiction of an example meta-model, in accordance with some embodiments herein;

FIG. 3 is an illustrative depiction of an example system architecture, in accordance with some embodiments herein;

FIG. 4 is an illustrative depiction of an example of dependencies for a query of the knowledge graph of FIG. 1, in accordance with some embodiments herein;

FIG. 5 is an illustrative depiction of an example of a computational subgraph for a query of the knowledge graph of FIG. 1, in accordance with some embodiments herein; and

FIG. 6 is an is an illustrative depiction of a block diagram of computing system, according to some embodiments herein.

### DETAILED DESCRIPTION

The following description is provided to enable any person in the art to make and use the described embodiments. Various modifications, however, will remain readily apparent to those in the art.

In an illustrative example of some aspects of the present disclosure, one or more frameworks, systems, and processes are disclosed to illustrate how they might function in an integrated system. In some aspects, an example herein may include a limited set of one or more equations. However, the set of equations are sufficiently robust and may be applied to examples extending beyond the specific examples presented herein.

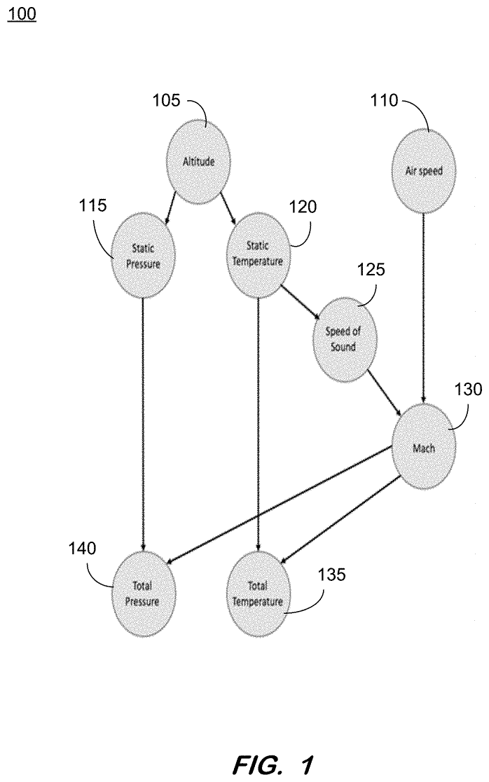

One illustrative example or scenario to illustrate some aspects of the present disclosure involves a hypersonic aerodynamics domain that is used as the application domain in FIG. 1. This example involves computations of air flow variables including Total Temperature 135 and Total Pressure 140 that are computed inputs of an Altitude variable 105 and an Air Speed variable 110. FIG. 1 is an illustrative representation of how the depicted variables in the hypersonic aerodynamics domain influence each other. For example, the Static Temperature 120 and the Static Pressure 115 are determined based on the Altitude 105; the Speed of Sound 125 depends on the Static Temperature 120; the Mach speed 130 depends on the Speed of Sound 125 and the Air Speed 110 of the moving object; and the Total Temperature is determined based on the Static Temperature 120 and the Mach speed 130. Similarly, the total pressure is determined based on the Static Pressure 115 and the Mach speed 130.

In some aspects herein, a knowledge graph may contain knowledge extracted from code and other sources. For the example scenario of FIG. 1, a domain model 100 for air flow variables is generated that includes specifications of equations for each concept in the diagram, except for the Altitude 105 and the Air Speed 110 that are only used as inputs in the scenario. The domain model may also specify each concept as a node of a Dynamic Bayesian Network (DBN). In some regards, a DBN node for a concept (e.g., variable) in the semantic model 100 of FIG. 1 provides additional information about the associated concept. For example, a DBN node definition might further specify or include a value range, a default distribution, a class or set of equations that may be used to compute a value for the node, etc. This additional information included in or represented by the DBN node may be useful in instances where the concept (e.g., variable) cannot be fully computed with the given inputs but can be treated as a random variable by the DBN Execution Framework (discussed in greater detail below). In some instances, a concept (e.g., the Mach variable) might be treated as a random variable in a particular scenario and network.

In some instances, some information (e.g., a range of values, a distribution, etc.) concerning a concept or variable might not be readily available for extraction from code and/or textual sources underlying a knowledge graph. In the event such information is not available in the knowledge graph and the information is needed for executing a computational graph, a process or system herein may request the additional information, along with any other required DBN information (e.g., a number of samples, tracking time steps, etc.,) by prompting a user (e.g., engineer, administrator, computer system, etc.) or other entity (e.g., data repository, cloud service, etc.) for such information. In some instances, one or more of the desired and/or required information may be a parameter having a default value, where the default value might be included or represented in a DBN node definition in the knowledge graph or other data source. In some aspects, a system herein may obtain desired or requisite information by referring to a similar, previously executed computational graph and using parameters therein.

In some aspects, an architecture or framework configured to support or facilitate systems and processes disclosed herein and the tasks they perform may comprise a number of different components.

In some embodiments, a central repository of all information may be stored in a “knowledge graph”. The knowledge graph is based on knowledge representation standards having emanated from, for example, Semantic Web research such as OWL (Web Ontology Language), RDF (Resource Description Framework), and Sparql (SPARQL Protocol and RDF Query Language). Multiple storage systems known as triplestores are available, both opensource and commercially. However, in developing some aspects of the present disclosure Apache Jena (an open source Semantic Web framework for Java) was used to access an in-memory knowledge graph. However, the present disclosure is not limited thereto and other tools may be used, such as Virtuoso by OpenLink Software, Amazon Neptune, and/other options might be used.

In some aspects, the information stored in a knowledge graph may be divided into three groups including domain knowledge, domain-independent knowledge, and meta-level knowledge. Herein, domain knowledge includes knowledge extracted by code analysis and Natural Language Processing (NLP) systems from code, text, and documents. Domain-independent knowledge includes semantic models that are used to represent extracted knowledge but are independent of any particular subject matter and thus can be reused across different domains. Meta-level knowledge represents information about activity that occurs in the system, including queries that have been submitted by a user, scientific models that have been constructed in response to a query, results obtained from executing a model, and the like.

The domain-independent model includes definitions of entities, such as for example, “UnittedQuantity,” and “Equation”. The semantic model for this part of the knowledge graph may be hand-crafted in SADL and maintained as part of an overall system. In some embodiments, a SADL deployment may include it as an implicit model. A “united quantity” is essentially a variable in a scientific model (e.g., the speed of sound) and has values and units as properties. An “equation” is a model that specifies inputs (or arguments), outputs (return types), and an expression to be used for the actual computation. In some instances, knowledge extraction may result in an opaque piece of code for which the inputs and outputs are known but a precise equation expression is not known. In some instances, the code may also be an opaque data-driven model. For these cases, the semantic model includes the concept of an “External Equation”, a type of Equation that links to (1) a location (i.e., data source) where the code is stored and (2) its identifier (a URI). Another concept defined here is the that of a “computational graph” and a subclass for representing Dynamic Bayesian Network (DBN) node information. Herein, a DBN node definition in a semantic model specifies links from the node (a variable) to an equation or an external equation, a type (deterministic, stochastic, discrete, continuous, etc.), a distribution (uniform, normal, Weibull, lognormal, exponential, beta, binomial, poisson, etc.), and a range of values. Other than the node and equations, these properties may be treated as defaults and may be ignored (e.g., if a DBN node is linked to a deterministic equation and values for all the inputs are provided, or overridden by a user before launching the execution). A DBN node definition for a root node (i.e., a node that does not depend on other variables) will not have an equation linked to it. Otherwise, the node variable corresponds to the output variable in the equation linked thereto.

A domain-independent model encoded in SADL may be represented by the following equation, external equation, and DBN node:

\hat{ }Equation is a class
described by input with values of type UnittedQuantity
described by output with values of type UnittedQuantity
described by expression with values of type string
described by assumption with values of type Condition.

\hat{ }ExternalEquation is a type of \hat{ }Equation
described by externalURI with values of type anyURI
described by location with values of type string.

DBNnode is a type of ComputationalGraph
described by nodeVariable with values of type UnittedQuantity
described by hasEquation with a single value of type \hat{ }Equation
described by hasModel with a single value of type \hat{ }ExternalEquation
described by ̂type with values of type NodeType
described by distribution with a single value of type Distribution
described by range with values of type Range.

In some embodiments, a domain-specific part of the knowledge graph 100 depicted in FIG. 1 for hypersonics knowledge around air flow can be developed. As shown, the domain-specific part of the knowledge graph for this example includes six equations/DBN nodes, one for each of the variables or concepts except for Altitude 105 and Air Speed 110 that are root nodes (i.e., strictly inputs that do not depend on other variables). As an example, the equations and DBN node definitions for Static Temperature 120 are as follows:

st_temp_eq_tropo is a StaticTemperatureEquation.

Equation st_temp_eq_tropo(double alt (altitude of some Air and alt<36152 {ft}))
returns double (staticTemperature of the Air {degF}):
return 59−0.00356*alt.

st_temp_eq_tropo has expression (a Script with script “59−0.00356*alt” language Python).

st_temp_eq_lowerStrato is a StaticTemperatureEquation.

Equation st_temp_eq_lowerStrato(double alt (altitude of some Air and alt<82345 and alt>=36152 {ft}))
returns double (staticTemperature of the Air {degF}):
return −70.

st_temp_eq_lowerStrato has expression (a Script with script “−70” language Python).

st_temp_eq_upperStrato is a StaticTemperatureEquation.

Equation st_temp_eq_upperStrato(double alt (altitude of some Air and alt>82345 {ft}))
returns double (staticTemperature of the Air {degF}):
return −205.05+0.00164*alt.

st_temp_eq_upperStrato has expression (a Script with script “−205.05+0.00164*alt” language Python).

StaticTempDBNnode is a type of DBNnode.

nodeVariable of StaticTempDBNnode always has value (a StaticTemperature with unit “degF”).

hasEquation of StaticTempDBNnode only has values of type StaticTemperatureEquation.

range of StaticTempDBNnode always has value (a Range with lower −200 with upper 300).

distribution of StaticTempDBNnode always has value uniform.

For the Static Temperature defined by the above equations and DBN node in this example, the Static Temperature is defined by three (3) equations that apply to different values of altitude. In general, equations will be associated with assumptions under which they are applicable and the system will need to check these assumptions to determine whether a DBN node using a particular equation can be chained together with other DBN nodes. The representing of assumptions can potentially include complex conditions and accounting thereof when constructing a computational graph herein may be accounted for by systems and processes herein.

The meta-model component of the knowledge graph is used for persisting queries, computational graphs, and execution events. The meta-model defines a class for “complex computational graph” (CCG) that are computational graphs comprised of a set of subgraphs, each of which is another computational graph (e.g., a DBN) but also linking to an output. Although DBN nodes link to an output variable, each subgraph will link to an output of the same type (i.e., same variable) but with an instantiated value and units. That is, the CCG will store the computed value for each node in the DBN, not only the leaf output node. These values of intermediate variables may be persisted and made available for explanation and follow-up or other types of queries. A concept, CGExecution (i.e., computational graph execution) may be used to represent execution events. In some aspects, a definition of a CGExecution includes start and end times, a link to the computational graph used (a CCG), and a measurement of the accuracy of the results obtained. A class CGQuery defined in the meta-model captures queries, whether submitted by a user or machine-generated. A CGQuery links to the inputs given in the query, each linking to a type (a unitted quantity) and the given value, and an CGExecution instance.

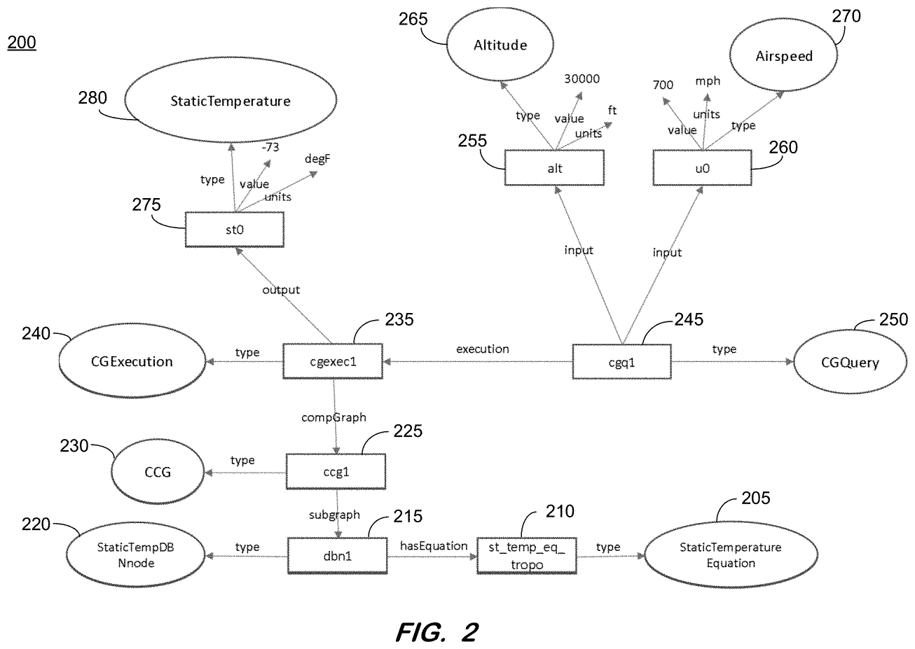

FIG. 2 is an illustrative depiction of an example meta-model 200 with a query's information captured in terms of the above-described meta-model concepts. For example, meta-model 200 defines a class CCG 230 that is a computational graph 225 comprised of a set of subgraphs (e.g., dbnl 215 that is an instance of DBN node 220) that is linked to an output (e.g., Static Temperature) defined by equation 210 of type 205. Furthermore, the class CGQuery 250 defined in meta-model 200 captures query 245. As shown, an instance 245 of the CGQuery 250 links to the inputs 255 and 260 specified in the query, with each input linking to a type (i.e., a unitted quantity 265, 270) and its associated given value, and an CGExecution instance 235 of the CGExecution class 240. In the example of FIG. 2, the instance 275 of the static temperature equation (st0) is linking to a type (i.e., a unitted quantity 280) and an associated given value.

In some aspects, a meta-model component of the knowledge graph herein includes definitions for three types of objects (i.e., queries (e.g., FIG. 2, 245), computational graphs (e.g., FIG. 2, 225), and execution events (e.g., FIG. 2, 235)), but might be modified to include fewer, more, and/or different types of objects. In some embodiments, a meta-model herein may generally be broadly defined to also accommodate computational graphs that are not based on DBNs.

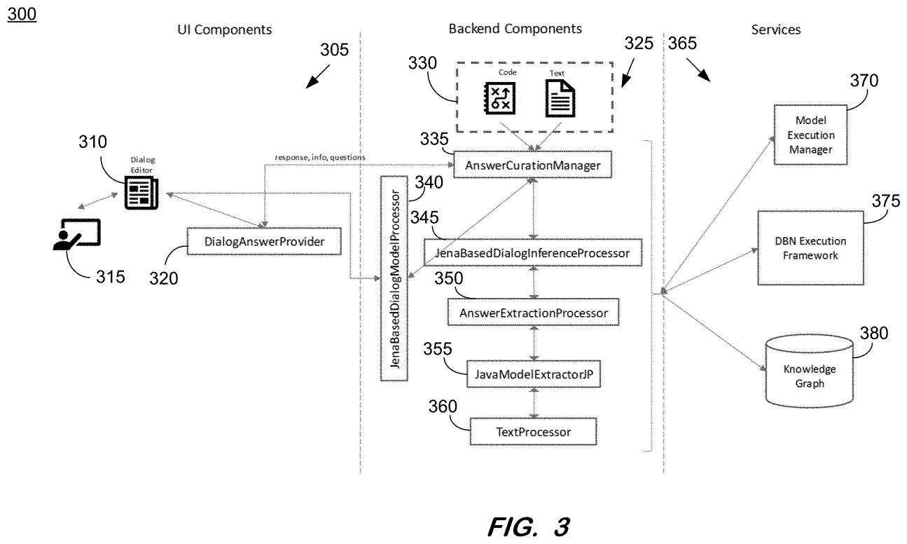

In some embodiments, as illustrated in FIG. 3, a user interface 305 for a system architecture 300 herein may include a controlled-English dialog editor 310 that provides a mechanism for a user 315 to interactively enter queries into the system and receive answers (i.e., replies to queries) in a “chat” style dialog. In some aspects, controlled-English has proven to be an effective manner to build, read, and understand semantic models. In particular, the Semantic Application Design Language (SADL) implements a controlled-English grammar with the expressivity of OWL 1 plus qualified cardinality constraints from OWL 2, as well as rules. It also supports queries, along with tests, explanations, and other model maintenance aids. The SADL grammar and integrated development environment (IDE) is implemented using Xtext, a framework for the development of domain-specific languages. In some aspects, Applicant(s) have created and extended the dialog language as an extension of the SADL language.

In some embodiments, the dialog grammar enables a user to create a dialog conversation in a dialog editor user interface window and specify a knowledge graph to serve as the domain of discourse. Once created, the dialog's OWL model that extends the selected domain model with any new knowledge captured in the conversation, is usable for query and inference. In some embodiments, the created model may be persisted as an OWL file that contains the domain reference and the new knowledge. New or modified content in the dialog editor may be passed both to the UI component (e.g., DialogAnswerProvider 320) and the backend component 325 (including, for example, one or more of an AnswerCurationManager 335, JenaBasedDialogModelProcessor 340, JenaBasedDialogInferenceProcessor 335, AnswerExtractionProcessor 350, JavaModelExtractorJP 355, and TextProcessor 360) that interact with each other and process source data 230 (e.g., code and text) based on information and functionalities provided by services 265, including for example, a model execution manager 270, a DBN Execution Framework 275, and a knowledge graph 280.

In some embodiments, a dialog interface herein may be implemented as part of a SADL Eclipse frontend. In some aspects, the focus may be on queries that result in scientific model assembly and execution thereof to compute an answer to the queries, as well as on elaboration and follow-up queries. In some embodiments, the grammar may be extended to parse queries. In some aspects, a dialog interface may support general queries of the knowledge graph and make general domain knowledge accessible to a user in an easy to understand format. In some embodiments, a dialog interface herein might provide a mechanism for a user to be able to enter new concept definitions to be added to the domain knowledge. For example, if during the course of an interaction with the system a user discovers that a scientific concept she knows about is missing from a knowledge graph, the user may be able to add the definition to the knowledge graph by expressing it in SADL via the dialog interface. Upon receipt of the user's input via the dialog interface, the system may add this new concept definition to the knowledge graph, wherein it might be immediately available as part of the domain's knowledge. In some embodiments, after a user enters the new piece of knowledge in the dialog interface, the user may be able to resume the work they were doing, without the need to switch UIs or restart the system(s).

In some embodiments, a dialog interface may include grammar expanded for other types of scientific model queries, such as for example, diagnostic queries. In some embodiments, the grammar may be extended to allow explanatory follow-up queries that may refer, implicitly or explicitly, to previous queries, in addition to the already supported general queries about scientific concepts in the knowledge graph.

For the example scenario of FIG. 1, we will disclose a number of queries that illustrate the functionality of a system herein. In some instances, the queries may be entered into the system via a SADL Dialog Interface, where SADL (Semantic Application Design Language) is an open source controlled-English language for building models and queries for retrieving information from those models. However, the present disclosure is not limited to these particular query entry input systems and user interfaces. An example SADL query entry might include:
What is the totalTemperature and the totalPressure when the altitude is 30000 ft and the airSpeed is 1000 mph?

A processor-enabled editor of the system recognizes the concepts in the knowledge graph (e.g., FIG. 1, 100) that are included in the query. In one example, the dialog editor may use highlighting in a user interface presentation to indicate the type of entity recognized in the query such as, for example, the color blue for concepts (e.g., TotalTemperature, and Altitude) and the color green for properties (e.g., totalTemperature). Based on the input of the query above, the system determines that it needs the equations for all the nodes shown in FIG. 1 since a determination of the value for the Total Pressure 140 and the Total Temperature 135 is based on the inputs of Altitude 105 and Air Speed 110 that involves all of the concepts/variables of FIG. 1.

As another example, the following query only asks for the total temperature:
What is the totalTemperature when the altitude is 30000 ft and the airSpeed is 1000 mph?

In this example, the system determines, based on the input query, that it does not need the equations for the Static Pressure 115 and the Total Pressure 140 to determine an answer to the query. As such, the system constructs a subgraph necessary to answer the query. The generated subgraph may be used is used downstream to construct a DBN specification to be submitted to a DBN Execution Framework.

In the following query, a value for the Total Temperature is requested wherein the query only provides a value for the altitude.
What is the totalTemperature when the altitude is 30000 ft?

In this example, the system determines, as seen from FIG. 1, that a speed input is absent and will have to be sampled. In an effort to minimize effort, the system may decide to sample Mach values instead of sampling air speed. In this example, the system may compute a subgraph that does not include Air Speed 110 nor an equation for Mach speed 130, wherein values for the Mach speed will be sampled according to a specified value range and distribution.

In some aspects, a process herein operates to assemble a model based on a graph of a knowledge base that can be processed to answer a query. In some embodiments, in response to a user submitting a query, the system accesses the knowledge graph to determine a set of equations that can be chained or linked together to compute an answer from the given inputs specified in the query. As an example using the hypersonics domain knowledge base graph introduced in FIG. 1, consider the following user-submitted query of:
What is the totalTemperature when the altitude is 30000 ft?

In response to receiving this example query, the system attempts to determine a set of equations that can be used to compute the query's requested Total Temperature based on the Altitude specified in the query. In the present example, the query is written in SADL (or other semantic ontology language) and a SADL (or other applicable) parser identifies and recognizes both the total temperature property and the altitude property specified in the query as entities present in the knowledge graph. Using the equations associated with the properties and corresponding concepts (TotalTemperature and Altitude) in the knowledge graph, the system generates a graph of dependencies among the variables (i.e., concepts) and adds that information to the knowledge graph using a ‘parent’ property.

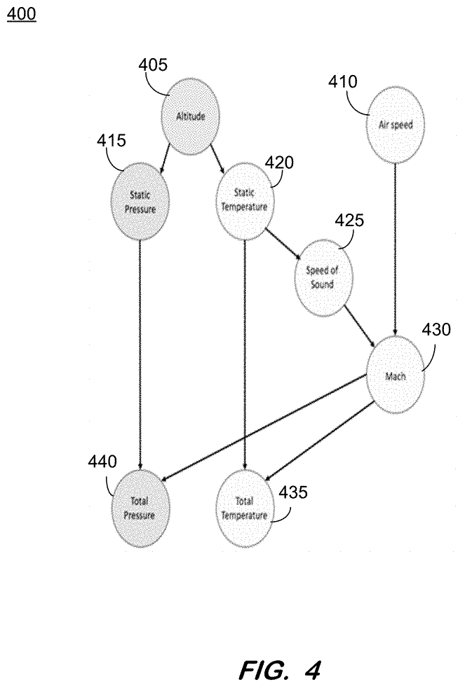

As an example, starting with the knowledge graph of FIG. 1, the system determines or finds all of the variables in the knowledge graph that the concept or variable Total Temperature specified in the query depends on. The dependencies are illustrated in FIG. 4, where the ancestors inclusive of Total Temperature are depicted by the shaded concepts 405, 410, 420, 425, 230 and 435. Referring to FIG. 4, it is noted that while Altitude 405 and Air Speed 410 are both root nodes, only Altitude 405 is specified as an input in the query. The nodes 410, 420, 425, 430, and 435 are candidates for which an equation or model is needed to answer the query.

In a next step, the system looks at descendants of the input(s) (e.g., Altitude 405) specified in the query and eliminates nodes that depend on variables that are not among the specified inputs. In the present example, this operation will remove Air Speed 410 and Mach 430 from the set of candidates. Total Temperature depends on Mach, so removing the Mach equation from the candidate set means Mach 430 will be treated as an input. Air Speed 410 on the other hand is removed from the subnetwork of dependencies because it is completely independent of the given input(s) (e.g., Altitude 401). In Bayesian terms, all other nodes are independent of Air Speed given Mach. Since Mach is not a given input in the query (i.e., no value is specified or given for it in the query), a DBN execution framework in accordance with the present disclosure may treat the Mach speed variable 430 as a random variable and use sampling to obtain values using a specified distribution for Mach.

In some aspects, an advantage of a knowledge graph herein is that it may facilitate complex graph pattern-matching through a query language (e.g., Sparql). For example, the knowledge graph facilitates and provides a mechanism to build a computational subgraph using a single query after the dependency graph has been inferred and added to the knowledge graph, as disclosed hereinabove.

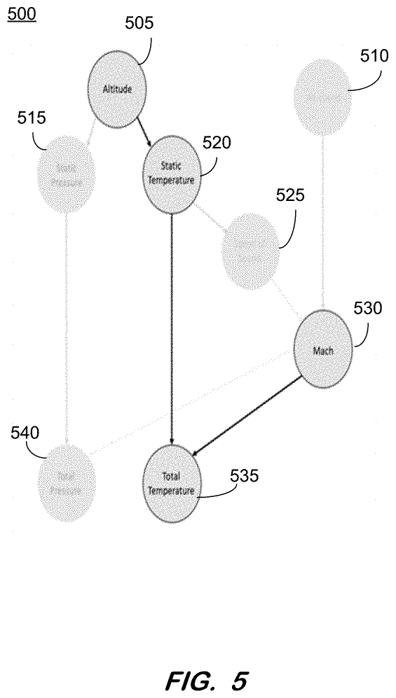

In a further process, step, or operation, equations whose output is not required by any other equation are removed from the set. In the present example, this determination step removes the Speed of Sound 525 equation since its output is not needed by the Mach 530 node since values of Mach 530 will be sampled instead of computed as discussed above and no other equation(s) needs Speed of Sound as an input. An illustrative depiction of the resulting model for answering the query is shown in FIG. 5.

In some embodiments, if a model is almost complete, i.e., the system found a set of equations that form a complete computational graph except for missing an equation or model to compute a few variables, this information may be provided as feedback to the text and code knowledge extraction subsytems and trigger knowledge extraction targeted at the specific missing variables. In some other scenarios, the system may find a seemingly “complete” model for the desired output although the “complete” model does not use all of the inputs specified in the query. In some instances, human and/or automated system action may be useful in the case of a seemingly “complete” having missing inputs as this may indicate that the query should be modified or that the model is incomplete. Some embodiments may be expanded to accommodate use-cases where an input is a data set and instead of an equation, the system may need to determine a data-driven model that can be applied given the characteristics of the data set.

In some embodiments, a system, framework, and process herein might incorporate reasoning regarding the assumptions under which equations are applicable. For example, in one of the examples herein different equations for the value of Static Temperature are applicable depending on the value specified for the Altitude. Also, all of the equations in the example scenario(s) herein assume that the medium through which an object is moving is air. Therefore, when constructing a scientific model (i.e., computational graph, subgraph) in accordance with some aspects herein by chaining together equations and other component models, the system, framework, and process should take steps to ensure that the equations for an answer are all applicable under consistent assumptions.

In some embodiments, after, in response to, or once the system computes a computational model for the desired (i.e., queried) output, the model may be translated into a format required by a DBN Execution Framework or some other model execution framework. This task may be performed by a Model Execution Manager module that may retrieve the assembled model from the knowledge graph, translate it into the required format (e.g., JavaScript Object Notation (JSON) or other format), and launch the DBN execution via, for example, a REST service provided by the DBN Execution Framework.

In some embodiments, the translation may be carried out via a lightweight microservice layer or another mechanism. Once the nodes and equations for the model are retrieved from the knowledge graph and assembled into Sparql-specific result sets, they may first be translated into some intermediate JSON (or other) tabular form, that facilitates easy downstream translation into a format expected by the DBN Execution Framework. Such a process not only provides flexibility should the specifications of the DBN execution JSON format change, but also provides a mechanism to optionally serve multiple downstream model execution frameworks (i.e., one or more other than DBN).

In some embodiments, the DBN Execution Framework may be based in the Python programming language and configured to be a service using the Flask microframework (other might be used) that can process RESTful dispatches. In one instance, a version of the Execution Service can be provided in the repo. In some aspects, a Model Execution Manager generates the JSON object that represents the model as a DBN and sends it as a REST request to the DBN Execution Service, wherein the DBN Execution Service receives the JSON as an input, evaluates the network to execute the query, and returns the results as a response or answer to the query.

In some of the example queries hereinabove, a DBN execution service might return, for example, the computed Total Temperature and Total Pressure when inputs are specified for the Altitude and Speed. In some instances when only an Altitude input is provided (i.e., no Mach speed valued specified), the execution framework may use an established random distribution assigned to the Mach variable and compute a probability distribution (or histogram in a discrete sense) of the Total Temperature and Pressure.

In some embodiments, Applicant(s) have realized that based on which nodes have input data associated with them, a DBN framework herein may automatically evaluate the overall system in the current examples of a prognostic query. In some aspects, a DBN framework herein might also effectively address other query scenarios including for example, a calibration query for which the system might automatically update parameters in the model when data for outputs in the model are provided, a sensitivity query for which the system may automatically output the amount of variance contribution to the output from the uncertainty of each of the different inputs, and an optimization query for which the system might automatically run an optimization to answer queries such as what input settings or distributions will result in the maximum efficiency of an engine design or the smallest specific fuel consumption etc.

In some embodiments, one of the processing tasks that might be triggered when a user (e.g., FIG. 3, 315) submits a query in a dialog interface of a system (e.g., FIG. 3, 300) herein is the ingestion of the query itself into the knowledge graph. This task may be carried out by, for example, a JenaBasedDialogProcessor component (e.g., FIG. 3, 340, 345), which is a backend (e.g., FIG. 3, 325) component that is independent of the UI frontend (e.g., FIG. 3, 305) components and could be used with a UI different from the example Eclipse SADL dialog interface. When a query is persisted, a knowledge graph instance of a meta-model concept CGQuery may be created. This instance may be linked to scientific concepts used as inputs (e.g., Altitude (e.g., FIG. 2, 265)) and the specified values or data sets. After further downstream processing, the query instance may also be linked to an instance of the meta-model concept CGExecution (e.g., FIG. 2, 235). That is, it is linked to the model execution event triggered by the query. In reference to the example query used hereinabove, the CGQuery instance, in SADL, might be:

cgq1 is a CGQuery
input (an Altitude with \hat{ }value 30000)
output (a TotalTemperature)
with execution (a CGExecution cge1 with compGraph cg1).

It is noted that the query instance cgq1 (e.g., FIG. 2, 245) is linked to a CGExecution instance cgexec1 (e.g., FIG. 2, 235) that in turn is linked to a computational graph instance cg1 (e.g., FIG. 2, 225). These instances need not be created and ingested into the knowledge graph at the same time. However, after the query-answering cycle is complete they will all be linked together.

The CGExecution concept will capture information about the execution event, including for example, start and end time, the computational graph used, and if applicable, a measurement of the accuracy obtained by the model (e.g., the root-mean-square error).

The computational graph may be persisted as an instance of the meta-model class CCG that was introduced herein. This object could be connected to the selected subgraphs assembled together, where each subgraph corresponds to a node in the dependency graph and therefore to a DBN node and equation. The subgraph is also linked to the equation's output and value obtained. For one example herein, the computational graph instance, in SADL, might be:

cg1 is a CCG
subgraph sg1
subgraph sg2
subgraph sg3.

sg1 is a SubGraph
cgraph (a StaticTempDBNnode hasEquation (a StaticTempEq))
output (a StaticTemperature \hat{ }value 483).

sg2 is a SubGraph
cgraph (a MachSpeedDBNnode distribution uniform)
output (a MachSpeed \hat{ }value 1.0 \hat{ }value 1.5 \hat{ }value 2.0).

sg3 is a SubGraph
cgraph (a TotalTemperatureDBNnode hasEquation (a TotalTemperatureEq))
output (a TotalTemperature \hat{ }value 2000 \hat{ }value 2500 \hat{ }value 3000).

In one embodiment, each subgraph is linked to a DBNnode and either an equation or a distribution. For example, since Mach speed is sampled (as discussed earlier in at least one example above), the corresponding subgraph sg2 links to a MachSpeedDBNnode instance with a distribution. The distribution is persisted because the user may have overridden the default distribution. As for values, Static Temperature is a deterministic node and has a single computed value, whereas Mach speed was sampled and thus has multiple values, as does Total Temperature that receives the Mach speed as one of its inputs (e.g., FIG. 3).

In some aspects, all of the information concerning the input query and the determined computational graph, including the equations, distributions, dependencies, etc. associated therewith may be available in the knowledge graph after the execution of the model. In some embodiments, a user may be presented with not only the output value in response to the query input but also, if desired, the values of all intermediate nodes. In some embodiments, the subgraph elements might also be persisted and accessible for inspection. Accordingly, in some embodiments, a user might be able to inspect intermediate nodes and submit follow-up questions (i.e., queries) about the scientific concepts used in the model.

In some aspects, having the queries and corresponding computational graphs and results stored in the knowledge graph provides a mechanism for a system herein to perform meta-reasoning (i.e., to reason over current and previous queries, models, and results). In some instances, meta-reasoning might be useful in, for example, explaining results to a user. For example, consider a query asking:
What is the machSpeed when altitude is 30000 ft and airSpeed is 2000 ft/sec?

Based on this query, the user gets the answer of 2.947. The user may then try the same query with an altitude of 40000, which produces an answer of 3.028. The user might then submit the query with an altitude of 50000 and get the same answer of 3.028. In response to getting the same result even though the values for the altitude varied, the user might want to know why that is the case. In some embodiments, a system, framework, and process herein might be able to provide insight into how the computational graphs used to answer the queries are different and determine that the computational graph for the first query is different from the computational graph for the second and third queries. In this example, the equation used to compute the Static Temperature for the first query is 518.6−3.56*Altitude, whereas for the second and third queries the Static Temperature is a constant 389.98 K. In some instances, the user could then use follow-up questions about hypersonics knowledge and obtain the explanation that the temperature in the lower stratosphere (e.g., between altitudes of 36152 and 82345 ft) is constant.

In an alternative scenario, the computational graph may include a node that uses a data-driven model instead of a deterministic equation. In this case, when the user requests an explanation for a surprising, unexpected, or otherwise interesting variation in the output, the system could launch a sensitivity analysis on the computational graph used to answer the user's queries. This process might involve retrieving the computational graph and requesting the DBN Execution Framework to do a sensitivity analysis instead of (or in addition to) the prognosis tasks previously done to answer the original user's queries.

In some embodiments, the dialog interface grammar is expanded and one or more algorithms are implemented to facilitate and support a process to compare computational graphs.

In some embodiments, in addition to asking queries, a user or other entity (e.g., a system, device, or service) may have observational data and wish to find a model that best explains the data. In this scenario, a system herein might automatically hypothesize models and accompanying knowledge graph(s) that may explain the observed data. In this situation, the system can proceed in a number of different ways depending on the variables present in the data and the existing models in the knowledge graph. For example, the system might determine and/or assemble several models that include all variables present in the data. The system may then execute the models to obtain a measure of each model's accuracy (e.g., mean error). Then, the system might select the most accurate model(s) and present them to the user in a readable form (e.g., a diagram similar to FIG. 5, as a set of equations in SADL, etc.). The results may also include the assumptions made by each model and the accuracy of each model.

In one embodiment, the system might determine or find only one model (or the user selects one of the models found in the previous case). The system may then use this one model to perform a sensitivity analysis to determine which input is the main contributor to the output. The system may then present the results to the user, with the intention of providing further explanation of the observed data.

In another embodiment, the system finds or determines a model that includes all the observed variables, the data satisfies the model assumptions, but the model accuracy is too low (i.e., the model does not fit the data). In this scenario, the system might attempt to compute a delta function (i.e., a model of the error) that may be, for example, a regression model, a neural network, or some other type of model. The system may then use the new model with the computed delta term as a hypothesis that is added to the knowledge graph.

In yet another embodiment, the system finds or otherwise determines a candidate model that includes all the observed variables but whose assumptions are not satisfied. In this case the system might present the model and the assumptions that are not satisfied by the data to the user and also provide that feedback to other systems to search for alternatives (e.g., equations or submodels) that apply under different assumptions.

In one embodiment, the system might fail to assemble a model that may explain the data. This might be the case because a relationship between two variables cannot be found or a variable is not even recognized. The system may then compute measures of correlation between the input variables and the output variables to determine whether there are variable relationships that are not captured by the knowledge graph. In the instance there are, then this information can be presented to the user and passed on as feedback to other systems that can then search for and extract the missing knowledge. It may also be possible that the user knows of the missing knowledge (e.g., an equation that relates some variables) and the user might enter the knowledge into the system via a user interface thereof such as a dialog interface.

As disclosed above, one or more embodiments and aspects herein provide mechanism(s) to extract and use knowledge around scientific models, not data in general, to determine, at least semi-automatically, a set of scientific models that can be used to answer a given question (i.e., query) and automatically compose the models into one executable that can compute the answer to the given question.

All systems (e.g., FIG. 3, system architecture 300) and processes (e.g., the generation of meta-models based on knowledge graphs(s), the execution of queries, etc.) discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software. In some embodiments, the execution of program code and other processor-executable instructions may be implemented by one or more processor-based devices, systems, and services, including but not limited to general purpose computing devices and systems and/or dedicated specific-purpose devices and systems, configured to implement the systems and processes disclosed herein.

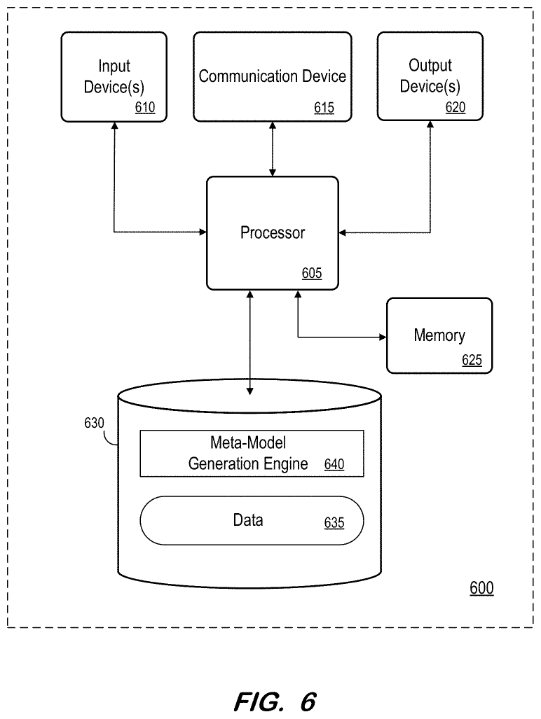

FIG. 6 is a block diagram of computing system 600 according to some embodiments. System 600 may comprise a general-purpose or special-purpose computing apparatus and may execute program code to perform any of the methods, operations, and functions described herein. System 800 may comprise an implementation of one or more systems (e.g., 300) and processes disclosed herein. System 600 may include other elements that are not shown, according to some embodiments.

System 600 includes processor(s) 605 operatively coupled to communication device 615, data storage device 630, one or more input devices 610, one or more output devices 620, and memory 625. Communication device 615 may facilitate communication with external devices, such as a data server and other data sources. Input device(s) 610 may comprise, for example, a keyboard, a keypad, a mouse or other pointing device, a microphone, knob or a switch, an infra-red (IR) port, a docking station, and/or a touch screen. Input device(s) 610 may be used, for example, to enter information into system 600. Output device(s) 620 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 625 may comprise Random Access Memory (RAM), Storage Class Memory (SCM) or any other fast-access memory. Data 635 including, for example, meta-model representations of knowledge graph(s) of processes and/or portions thereof disclosed herein, and other data structures may be stored in data storage device 630.

Meta-model generation engine 640 may comprise program code executed by processor(s) 605 to cause system 600 to perform any one or more of the processes or portions thereof disclosed herein. Embodiments are not limited to execution by a single apparatus. Data storage device 630 may also store data and other program code for providing additional functionality and/or which are necessary for operation of system 600, such as device drivers, operating system files, etc.

Embodiments described herein are solely for the purpose of illustration. Those in the art will recognize other embodiments may be practiced with modifications and alterations to that described above.

What is claimed is:

1. A system comprising:
a memory storing processor-executable instructions; and
a processor to execute the processor-executable instructions to cause the system to:
receive a query to execute against a knowledge graph, the knowledge graph representing information pertaining to a particular ontology domain and the query including at least one variable represented by the knowledge graph;
examining the knowledge graph to identify variables therein that are also specified in the query;
generate a model based on the query and the identified variables in the knowledge graph, an execution of the model providing an answer to the query; and
transmitting a record of the generated model to a data store and persisting the record in the data store.

2. The system of claim 1, wherein the generating of the model includes determining a dependency graph of input variables specified in the query and eliminating nodes that depend on variables that are not among the specified inputs.

3. The system of claim 2, wherein the processor is further enabled to execute processor-executable instructions to cause the system to:
add the determined dependency graph to the knowledge graph and further generating the model based on the determined dependency graph.

4. The system of claim 1, wherein the received query is a given user query and the generated model is executed to compute an answer to the given user query.

5. The system of claim 1, wherein the processor is further enabled to execute processor-executable instructions to cause the system to:
execute the model included in the record to generate an answer to the query; and
saving the answer to the query in a memory.

6. The system of claim 1, wherein each of the at least one variable represented by the knowledge graph are represented by a Dynamic Bayesian Network.

7. A computer-implemented method, the method comprising:
extracting, by a processor, information from at least one of code and text documentation, the extracted information conforming to a base ontology and being extracted in the context of a knowledge graph;
receiving, by a processor, a query to execute against a knowledge graph, the knowledge graph representing information pertaining to a particular ontology domain and the query including at least one variable represented by the knowledge graph;
examining, by the processor, the knowledge graph to identify variables therein that are also specified in the query;
generating, by the processor, a model based on the query and the identified variables in the knowledge graph, an execution of the model providing an answer to the query; and
transmitting, by the processor, a record of the generated model to a data store and persisting the record in the data store.

8. The method of claim 7, wherein the generating of the model includes determining a dependency graph of input variables specified in the query and eliminating nodes that depend on variables that are not among the specified inputs.

9. The method of claim 8, further comprising adding the determined dependency graph to the knowledge graph and further generating the model based on the determined dependency graph.

10. The method of claim 7, wherein the received query is a given user query and the generated model is executed to compute an answer to the given user query.

11. The method of claim 7, further comprising:
executing the model included in the record to generate an answer to the query; and
saving the answer to the query in a memory.

12. The method of claim 7, wherein each of the at least one variable represented by the knowledge graph are represented by a Dynamic Bayesian Network.

13. A non-transitory computer-readable medium storing instructions that, when executed by a computer processor, cause the computer processor to perform a method comprising:
extracting information from at least one of code and text documentation, the extracted information conforming to a base ontology and being extracted in the context of a knowledge graph;
receiving a query to execute against a knowledge graph, the knowledge graph representing information pertaining to a particular ontology domain and the query including at least one variable represented by the knowledge graph;
examining the knowledge graph to identify variables therein that are also specified in the query;
generating a model based on the query and the identified variables in the knowledge graph, an execution of the model providing an answer to the query; and
transmitting a record of the generated model to a data store and persisting the record in the data store.

14. The medium of claim 13, wherein the generating of the model includes determining a dependency graph of input variables specified in the query and eliminating nodes that depend on variables that are not among the specified inputs.

15. The medium of claim 14, further storing instructions that, when executed by a computer processor, cause the computer processor to perform the method comprising adding the determined dependency graph to the knowledge graph and further generating the model based on the determined dependency graph.

16. The medium of claim 13, wherein the received query is a given user query and the generated model is executed to compute an answer to the given user query.

17. The medium of claim 13, further storing instructions that, when executed by a computer processor, cause the computer processor to perform the method comprising:
executing the model included in the record to generate an answer to the query; and
saving the answer to the query in a memory.

18. The medium of claim 13, wherein each of the at least one variable represented by the knowledge graph are represented by a Dynamic Bayesian Network.
